(19) United States
(12) Patent Application Publication
(10) Pub. No.: US 2004/0190473 A1
(43) Pub. Date: Sep. 30, 2004

(54) Method for detecting communication speed of apparatus

(76) Inventors: Sam Chul Ha, Kyongsangnam-do (KR); Seung Myun Baek, Kyongsangnam-do (KR); Koon Seok Lee, Kyongsangnam-do (KR); Jeong Hyun Lim, Kyongsangnam-do (KR); Hwan Jong Choi, Kyongsangnam-do (KR); Ja In Koo, Kyongsangnam-do (KR); Dae Woong Kim, Kyongsangnam-do (KR); Sung Hwan Kang, Kyongsangnam-do (KR)

Correspondence Address: MCKENNA LONG & ALDRIDGE LLP, 1900 K STREET, NW, WASHINGTON, DC, 20006, US

(21) Appl. No.: 10/481,814

(22) PCT Filed: Apr. 9, 2002
(86) PCT No.: PCT/KR02/00636

(30) Foreign Application Priority Data
Jun. 26, 2001 (KR) 2001/36613

(51) Int. Cl. H04Q 7/00

(52) U.S. Cl. 370/332; 370/345

(57) ABSTRACT

A method for detecting a communication speed of an apparatus is disclosed. The method includes a step for storing a communication speed which is currently used or a communication speed of one bit; a step for detecting a communication speed of received data by using data of a first frame which are first input among the received data; a step for detecting a consistent communication speed by comparing the detected communication speed and an initialized communication speed; a step for recognizing that a communication error is found if a consistent communication speed is not found as a result of said detection and for setting a consistent communication speed as a communication speed between the two apparatuses if a consistent communication speed is found; and a step for inputting the received data by using the set communication speed and performing corresponding commands.

### TECHNICAL FIELD

The present invention relates to a method for detecting communication speed of an apparatus, and more particularly, to a method for detecting communication speed of transmitter by using signals being received.

### BACKGROUND ART

In general, communicational apparatuses have a built-in central processing unit and a universal asynchronous receiver transmitter (UART) port for intercommunication among apparatuses. A typically used communication method among apparatuses is a serial communication using RS-232C.

The serial communication speed is changed, depending on specification of central processing unit within an apparatus, appropriate point on communication path, and application usage during communication.

In addition, communication speed of EMS (Electronic Management System) currently being used has changed from 9600 Bps (bit per second) to 10400 Bps, in conforming to communication protocol ISO9141 of ISO (International Standardization Organization).

As a result, it is now impossible to do networking among apparatuses because communication speed of each apparatus changes when RS-232C is used. Moreover, in case that apparatuses that are currently being produced and apparatuses to be produced in future have different communication speed, it gets much more difficult to control the entire network as a whole in the middle of networking.

As an attempt to solve the problems, many tried to define communication protocol that is applicable to each apparatus before starting communication.

However, such method consumed too much time to set communication speed, and setting had to be done for individual apparatus.

Moreover, the entire system became bulkier because of a separate apparatus for converting communication speed.

### DISCLOSURE OF INVENTION

It is, therefore, an object of the present invention to provide a method for detecting communication speed of an apparatus, enabling to ease intercommunication between more than two apparatuses having different communication speeds without setting communication protocol in advance.

Another object of the present invention is to provide a method for detecting communication speed of an apparatus that does not require additional resources, by detecting communication speed based on received data.

To achieve the above object, there is the method for detecting communication speed of an apparatus, including the steps of: storing a communication speed which is currently used or a communication speed of one bit; detecting a communication speed of received data by using data of a first frame which are first input among the received data; detecting a consistent communication speed by comparing the detected communication speed and an initialized communication speed; recognizing that a communication error is found if a consistent communication speed is not found as a result of said detection and for setting a consistent communication speed as a communication speed between the two apparatuses if a consistent communication speed is found; and inputting the received data by using the set communication speed and performing corresponding commands.

If the input data during detection period of the communication speed is “0000 0000”, time period from a start bit to a stop bit of the first frame that is first input is detected.

If the input data during detection period of the communication speed is “1000 0000”, time period from a low edge to a next low edge of the first frame that are first input is detected.

### BRIEF DESCRIPTION OF DRAWINGS

The above objects, features and advantages of the present invention will become more apparent from the following detailed description when taken in conjunction with the accompanying drawings, in which:

FIG. 1 is a schematic diagram of communication among apparatuses in accordance with the present invention;

FIG. 2 diagrammatically illustrates received data that are input in the central processing unit in accordance with the present invention;

FIG. 3 is a diagram depicting a first embodiment for detecting a communication speed of received data in accordance with the present invention;

FIG. 4 is diagram depicting a second embodiment for detecting a communication speed of received data in accordance with the present invention; and

FIG. 5 is a flow chart showing a method for detecting a communication speed of an apparatus in accordance with the present invention.

### BEST MODE FOR CARRYING OUT THE INVENTION

A preferred embodiment of the present invention will now be described with reference to the accompanying drawings.

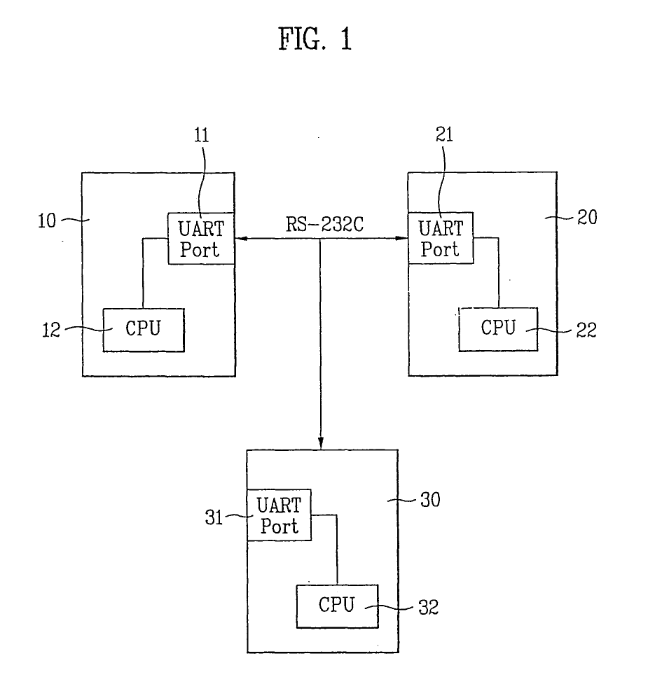

FIG. 1 is a schematic diagram of communication among apparatuses in accordance with the present invention.

As depicted in the drawing, a plurality of apparatuses with built-in UART (universal Asynchronous Receiver Transmitter) ports 11, 21, and 31, and CPU (central processing unit) 12, 22, and 32 are connected do serial communication by using RS-232C.

The UART ports 11, 21, and 31 performs communication with other apparatuses asynchronously under control of the CPU, and the CPU 12, 22, and 32, based on the transmitted data through the UART ports, detects the communication speed of received data, and then sets the communication speed to be automatic.

More details on how the CPU 12, 22, and 32 detects the communication speed of the received data are now provided with reference with drawings.

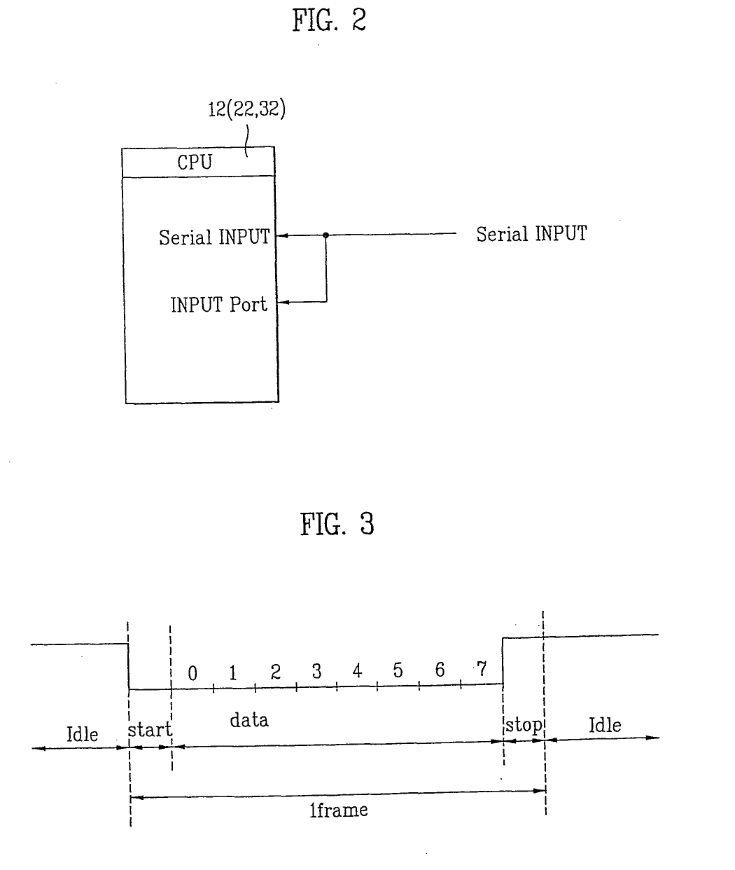

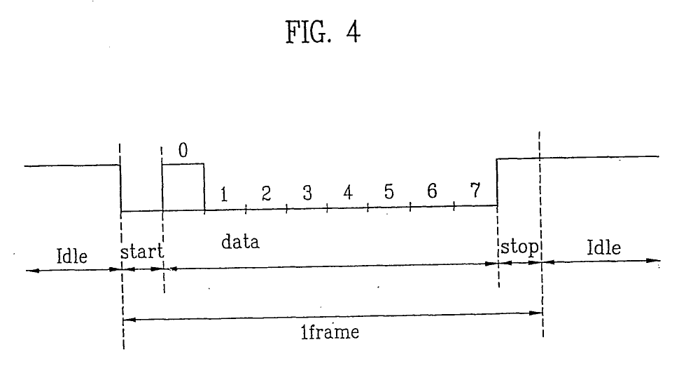

FIG. 2 diagrammatically illustrates received data that are input in the central processing unit in accordance with the present invention, and FIG. 3 is a diagram depicting a first embodiment for detecting a communication speed of received data in accordance with the present invention, and FIG. 4 is diagram depicting a second embodiment for detecting a communication speed of received data in accordance with the present invention.

As shown in FIG. 2, CPU 12, 22, and 32 receives only data of a first frame that are first input to an input port among the received data, and the data that are later input are sent to a serial input unit.

Here, the data of the first frame having been transmitted by a transmitting party has a particular data value to enable a receiving party to detect communication speed more easily. Once the first frame is received, the receiving party uses the detected communication speed only, and does not recognize the data value.

The data value of the first frame the transmitting party) transmitted includes 1 bit for start and end, respectively, and the data value is defined as 8 bits, i.e., a total of 10 bits. Therefore, the total data size of the first frame is defined as 10 bits.

Also, 8-bit data value can be designated as “0000 0000” as shown in FIG. 3, or “1000 0000” as shown in FIG. 4, to detect communication speed.

Referring to FIG. 3, time period from input time of the start bit to ending time of the stop bit belongs to one frame. If the communication speed is 9600 Bps, the communication of one frame is 9600/1 [sec].

In short, since the CPU on the receiving party detects total time period of the first frame that are first input, the communication speed for currently being received data can be obtained.

Having designated the first data value as 1, as illustrated in FIG. 4, time period from a low edge (where the start bit starts) to a high edge (where the first data bit ends) is detected.

Thusly detected time for one bit is then used for determining the communication speed of received data.

More specifically speaking on the embodiment presented in FIG. 4, the communication speed of one bit can be expressed by the following equation, given that the total bit number is defined as 10 bits including the start bit and the stop bit, and that the communication speed is 9600 Bps.

9600[Bps]/10=1.04[msec][ Equation 1]

In this way, the communication speed per bit is calculated when the communication speed is 960 Bps, 2400 Bps, 4800 Bps, 9600 Bps, and 12800 Bps, respectively. Then the calculation is stored in the CPU.

The communication speed per bit and the detection time period from the low edge to the high edge are compared with each other to decide the total communication speed.

The following describes the operation involved in detecting communication speed, by referring drawing(s).

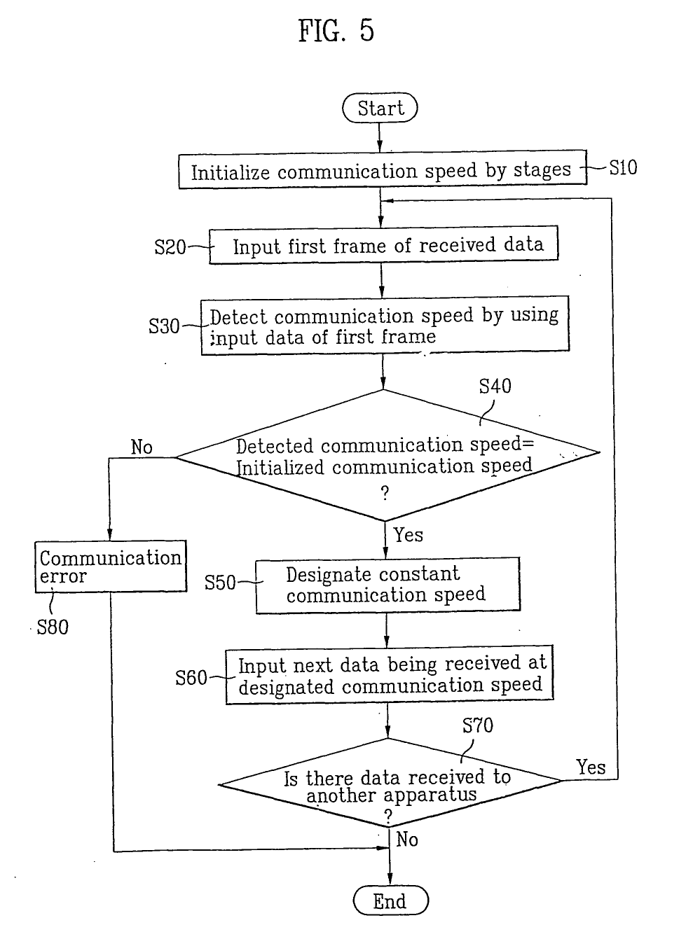

FIG. 5 is a flow chart showing a method for detecting a communication speed of an apparatus in accordance with the present invention.

As depicted in the drawing, communication speeds are stored in the CPU by stages. In other words, in case of the embodiment illustrated in FIG. 3, 960 Bps, 2400 Bps, 4800 Bps, 9600 Bps, and 12800 Bps are stored in the CPU, and in case of the embodiment illustrated in FIG. 4, communication speed per bit, the communication speed including 960 Bps, 2400 Bps, 4800 Bps, 12800 Bps, is stored in the CPU (S10).

After initializing the communication speed, the CPU receives, through an input data, data of a first frame that are first input (S20).

Based on the input data of the first frame, total time period from the start bit to the stop bit is detected (see FIG. 3), or communication speed of received data is detected by detecting time for 1 bit (see FIG. 4) (S30).

Then, the detected communication speed is compared with the initialized communication speed to get a constant communication speed (S40). If there is no such communication speed, one may conclude that a communication error is generated, and ends the detection procedure (S80).

On the other hand, if there is the constant communication speed, it is designated as the communication speed between the two apparatuses (S50).

Later, using the set communication speed, the received data is input in the serial input unit of the CPU, and corresponding commands are carried out (S60).

If there is data from another apparatus, the above procedure is repeated (S70).

While the invention has been shown and described with reference to certain preferred embodiments thereof, it will be understood by those skilled in the art that various changes in form and details may be made therein without departing from the spirit and scope of the invention as defined by the appended claims.

Industrial Applicability

The method for detecting communication speed of an apparatus embodying the principles of the present invention is advantageous in view that the size of hardware necessary for communication can be reduced, and communication between apparatuses can be done more easily by automatically or equally setting communication between two apparatuses with different communication speed from each other without separate resources.

What is claimed is:

1. A method for detecting communication speed of an apparatus, comprising the steps of:
initializing a communication speed by storing the communication speed which is currently used or the communication speed of one bit;
detecting a communication speed of received data by using data of a first frame which are first input among the received data;
detecting a consistent communication speed by comparing the detected communication speed and an initialized communication speed;
recognizing that a communication error is found if a consistent communication speed is not found as a result of said detection and setting a consistent communication speed as a communication speed between the two apparatuses if a consistent communication speed is found; and
inputting the received data by using the set communication speed and performing corresponding commands.

2. The method defined in claim 1, wherein the communication speed which is currently used is 960 Bps, 2400 Bps, 4800 Bps, 9600 Bps, or 12800 Bps.

3. The method defined in claim 1, wherein the communication speed is founded by detecting a time period from a start bit to a stop bit of a first frame which is first input.

4. The method defined in claim 3, wherein the input data is “0000 0000”.

5. The method defined in claim 1, wherein the communication speed is founded by detecting a time period from a low edge to a high edge of a first frame which is first input.

6. The method defined in claim 5, wherein the input data is “1000 0000”.
